(19) United States
(12) Patent Application Publication
(10) Pub. No.: US 2003/0059527 A1
(43) Pub. Date: Mar. 27, 2003

(54) Method for restoring local polymer coating of a previously stripped optical fibre

(76) Inventors: Philippe Lesueur, Perros-Guirec (FR); Claude Botton, Tregastel (FR); David Pureur, Perros-Guirec (FR)

Correspondence Address: Blakely Sokoloff Taylor & Zafman, 7th Floor, 12400 Wilshire Boulevard, Los Angeles, CA, 90025-1026, US

(21) Appl. No.: 09/914,288

(22) PCT Filed: Dec. 21, 2000
(86) PCT No.: PCT/FR00/03636

(30) Foreign Application Priority Data
Dec. 24, 1999 (FR) 99/16463

(51) Int. Cl. B05D 5/06

(52) U.S. Cl. 427/163.2

(57) ABSTRACT

The invention concerns a method for restoring the coating of a previously stripped optical fibre, characterised in that it comprises steps which consist in: applying a drop of viscous substance on one end of the fibre (10) stripped zone, at the interface (22) with the remaining initial coating (20), and shaping said drop into a mass (30) centre on the fibre (10) axis, tapering away from the adjacent initial coating (20), before filling up the fibre stripped space with a mass of substance capable of sheathing said fibre (10) again.

The present invention relates to the field of optical fibers.

More specifically, the present invention relates to the reconstitution of the protective coating, generally polymer-based, of an optical fiber prestripped over a short spatial dimension.

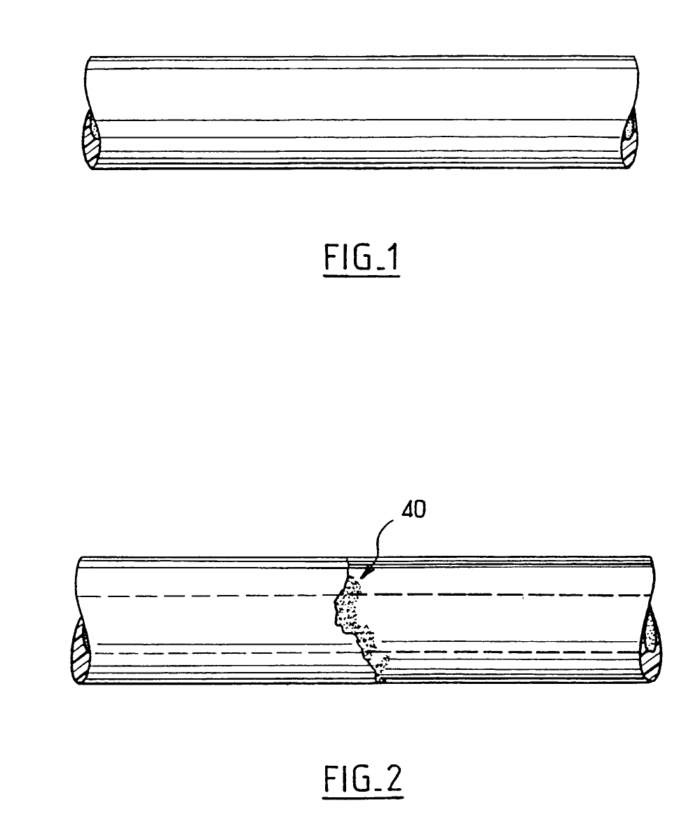

During the production of various components, for example frequency filters, integrated into an optical fiber, it is very often necessary to remove the protective coating of the fiber (see FIG. 1). This coating is usually a polymer, such as an acrylate, the crosslinking of which is obtained by exposure to UV radiation. To allow and/or facilitate the manufacture of the component, the polymer is therefore removed from the fiber by means of various mechanical, thermal or chemical methods [1]. After the component has been produced, the polymer sheath is reconstituted in order to improve the mechanical behaviour of the fiber and to prevent any contamination by oxidizing agents.

There are in the market several companies supplying machines capable of reconstituting the sheathing of the fiber [2]. Their main customers are, at the present time, optical telecommunication systems and equipment manufacturers working on terrestrial applications. As regards the submarine telecommunications market, this is much more draconian in terms of mechanical strength and lifetime of the components. However, very few machines are capable at the present time of meeting most of the conformity criteria regarding fiber resheathing quality. The main shortcoming of these machines is the delamination (or debonding) which occurs between the sheathed original region and the reconstituted region (see FIG. 2). The presence of air bubbles 40 (see FIG. 1) at this interface reduces the mechanical strength of the optical fiber over time.

It is now an object of the present invention to provide novel means making it possible to improve the local reconstitution of the coating, especially polymer coating, of a prestripped optical fiber over the known prior techniques.

This object is achieved within the context of the present invention by virtue of a method of reconstituting the coating of a prestripped optical fiber, characterized in that it comprises the steps consisting in:

applying a drop of a viscous material, for example of polymer or silicone, on one end of the stripped region of the fiber, at the interface with the remaining initial coating, and

shaping this drop into a mass which is centered on the axis of the fiber and tapered on going away from the adjacent initial coating, before

filling the stripped space of the fiber with a mass of material capable of resheathing said fiber.

The present invention also relates to the fibers obtained after implementing this reconstitution method.

According to another advantageous characteristic of the present invention, the shaping step consists in shaping the drop of viscous material into a mass having a generally frustoconical envelope.

Other features, objects and advantages of the present invention will become apparent on reading the detailed description which follows, together with the appended drawings, given by way of nonlimiting examples and in which:

FIG. 1 shows a known silica-based virgin optical fiber, the core of which having a diameter of 125 microns is covered with an acrylate polymer sheath having a diameter of 250 microns;

FIG. 2 shows the resheathing obtained with a machine commercially available at the present time, in which figure bubbles trapped at the sheathed virgin region/resheathed region interface may be seen;

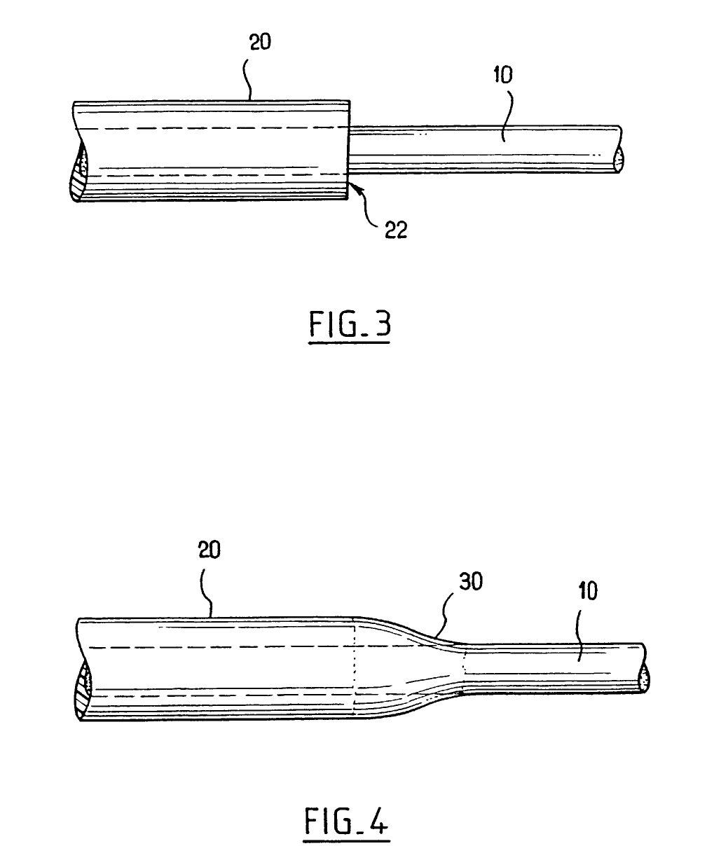

FIG. 3 show a fiber stripped, within the context of the present invention, so as to obtain a sharp and clean interface;

FIG. 4 shows the stripped fiber provided with a cone created at the interface with the original sheathing with the aid of a drop of molded polymer, in accordance with the present invention, the cone then being cured by UV radiation or by raising the temperature;

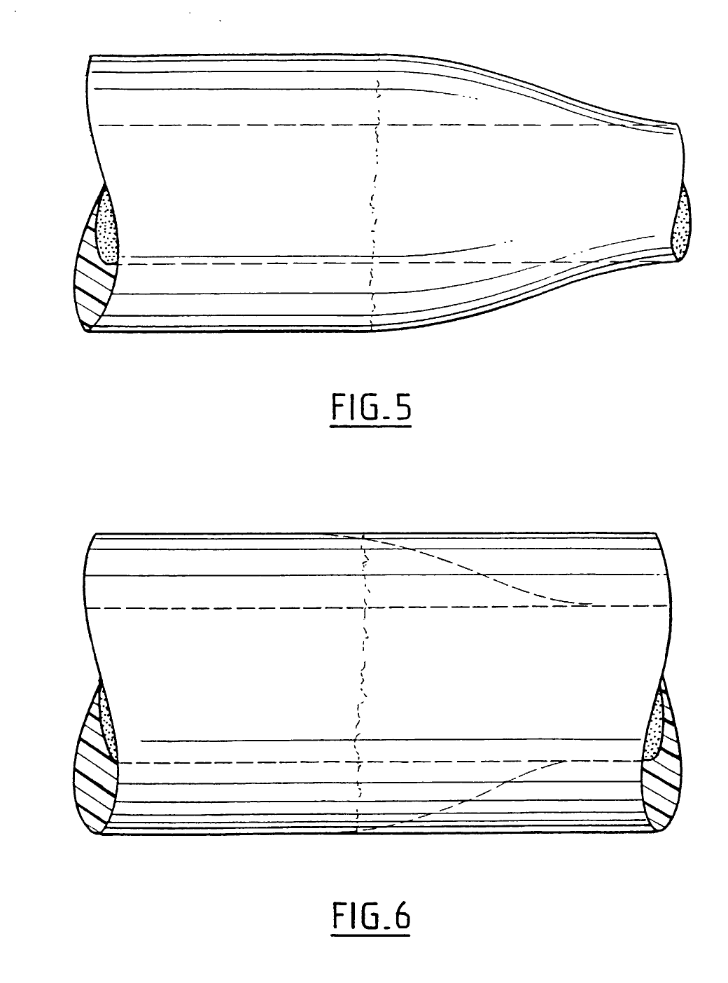

FIG. 5 shows an enlarged view of this cone, revealing a gentle slope at the interface between the stripped region and the nonstripped region, the length of the cone illustrated in FIG. 5 being between 1 and 5 mm; and

FIG. 6 shows the final optical fiber after stripping, manufacture of the cones in accordance with the present invention and resheathing.

It will be noted that, in FIG. 6, no trapped air bubble or debonding at the interface may be seen, unlike what may be seen in a conventional fiber as illustrated in FIG. 2.

The method of reconstituting the polymer coating of a prestripped optical fiber, in accordance with the present invention, will now be described in more detail with regard to the appended FIGS. 3 to 6.

Firstly, within the context of the invention, the fiber 10 is stripped of its polymer coating 20 over a region of a few millimeters/centimeters with a sharp cut into the polymer, as illustrated in FIG. 3, that is to say with a clear-cut interface 22 transverse to the axis of the optical fiber.

This makes it possible to prevent bubbles close to the sheathed fiber/air interface 22 from being trapped.

After the component has been produced in the fiber 10, a drop of polymer (of the order of a few mm³ and of viscosity equal to 5000 mpa.s) is deposited at each end of the stripped region. This drop is applied, as illustrated in FIGS. 4 and 5, between the silica fiber 10 and the polymer interface 22. It is then molded in order to assume the shape of a cone 30 centered on the axis of the fiber, with a diameter at its base of around 250 to 350 microns (for a fiber with an initial coating of 250 μm).

The shaping of the drop may be performed manually or with a machine designed for this purpose.

The polymer must be viscous enough to facilitate this operation. By way of indication, the viscosity must preferably be between 1000 and 10 000 mPa.s. Next, the two cones are crosslinked/cured by subjecting them for a few seconds/minutes to ultraviolet radiation or to a rise in temperature by any other suitable means. Furthermore, if the polymer is viscous enough, this step of crosslinking the cones is not necessary.

This operation may be repeated several times until the desired shape and structure are obtained. That is to say, in order to obtain the desired final cone, it is possible to deposit in succession several drops of polymer with successive shaping of each of them.

Once the cones have been formed, any commercially available machine for resheathing the central part of the stripped region can be employed. This machine delivers a given amount of polymer (depending on the length) which is distributed around the fiber, to be subsequently crosslinked.

Such resheathing may be carried out conventionally in one or more superposed layers of polymers over the entire stripped length.

Because of the presence of the cones 30, and therefore of a gentle interface between the sheathed and unsheathed regions, the final step of the reconstitution takes place without the appearance of air bubbles or without delamination.

Preferably, within the context of the invention, the inventors have found that the apex angle of the cone 30 must be between 5° and 70° in order to obtain an optimal result.

The resheathed final component with the cones according to the present invention is illustrated in FIG. 6.

Of course, the present invention is not limited to the particular embodiment which has just been described, but extends to any variant in accordance with its spirit.

In particular, the invention is not limited to the strict use of polymers for producing the cones. The present invention may be implemented with the aid of any equivalent material, such as with a silicone material for example.

Preferably, as indicated above, the material used to produce the cones is, however, thermally or UV-radiation crosslinkable. Of course, this facilitates the growth of the cone by successively depositing several drops and/or the complete resheathing of the prestripped region. Furthermore, the process can also be used for a fiber having a 400 or 900 μm coating.

The present invention applies particularly to the resheathing of optical fibers comprising integrated optical functions. This is because the present invention makes it possible to strip and resheath such fibers without impairing their mechanical strength over time. In particular, the present invention allows the fibers to be completely protected from external perturbations without modifying their mechanical behavior. The present invention applies in general to any optical fiber (filter, splice, etc.) requiring the removal then the local resheathing of the fiber.

The present invention is especially applicable in the submarine telecommunications market and sensor devices which require long component lifetimes.

The invention applies most particularly, but not exclusively, to the resheathing of an optical fiber in which a Bragg grating has been photowritten. At the present time, such a component is a key element of telecommunications and makes it possible in particular to carry out functions of filtering, isolating, stabilizing, extracting and routing a light wave [3].

Moreover, within the context of the present invention, the geometry given, after shaping, to the mass coming from the drop of viscous material deposited at the interface 22 with the remaining initial coating may not be completely frustoconical, the essential point being that this mass is tapered on going away from the said interface 22, in order to join up with the outer surface of the fiber with virtually no discontinuity (thereby corresponding to the expression “generally frustoconical envelope” used above).

[1] D. Varelas, “Mechanical reliability of optical fiber Bragg gratings”, Doctoral thesis from the University of Lausanne (Switzerland), 1998.

[2] Technical documentation on Vytran Corporation resheathing machines, 1999.

S. Boj, “Réalisations de filtres sélectifs en fréquence intégrés dans les fibres optiques et applications [Production of frequency-selective filters integrated into optical fibers and applications]”, Doctoral thesis from the University of Lille, 1995.

1. Method of reconstituting the coating of a prestripped optical fiber, characterized in that it comprises the steps consisting in:
applying a drop of a viscous material, on one end of the stripped region of the fiber (10), at the interface (22) with the remaining initial coating (20), and
shaping this drop into a mass (30) which is centered on the axis of the fiber (10) and tapered on going away from the adjacent initial coating (20), before
filling the stripped space of the fiber with a mass of material capable of resheathing said fiber.

2. Method according to claim 1, characterized in that the shaping step consists in shaping the drop of viscous material into a mass (30) having a generally frustoconical envelope.

3. Method according to one of claims 1 or 2, characterized in that the aforementioned steps of applying drops of viscous material and of shaping them are carried out on each end of the stripped region of the fiber.

4. Method according to one of claims 1 to 3, characterized in that it consists in repeating several times the steps of applying a drop of viscous material and of shaping it before the filling step is carried out.

5. Method according to one of claims 1 to 4, characterized in that the viscous material is a polymer.

6. Method according to one of claims 1 to 4, characterized in that the viscous material is a silicone.

7. Method according to one of claims 1 to 6, characterized in that it furthermore includes the step consisting in crosslinking the viscous material before the shaping step.

8. Method according to one of claims 1 to 7, characterized in that it furthermore includes the prior step consisting in making a sharp cut in the initial coating of the fiber, preferably in a plane orthogonal to the axis of the fiber (10).

9. Method according to one of claims 1 to 8, characterized in that the stripped region of the fiber (10) has a length of between a few millimeters and a few centimeters.

10. Method according to one of claims 1 to 9, characterized in that the volume of each drop of viscous material deposited at each application step is of the order of a few mm³.

11. Method according to one of claims 1 to 10, characterized in that the diameter at the base of the cone (30) is around 250 to 350 microns.

12. Method according to one of claims 1 to 11, characterized in that the apex angle of the cone (30) is around 5 to 70°.

13. Method according to one of claims 1 to 12, characterized in that the viscosity of the material applied is between 1000 and 10 000 mPa.s.

14. Method according to one of claims 1 to 13, characterized in that it furthermore includes the step consisting in forming a Bragg grating in the stripped region of the fiber (10) before it is resheathed.

15. Optical fiber obtained by implementing the method according to one of claims 1 to 14.

16. Fiber according to claim 15, characterized in that it comprises two cones (30) respectively adjacent to the end interfaces of a locally removed original coating (20), these being covered with a final resheathing.
